(19) United States
(12) Patent Application Publication
(10) Pub. No.: US 2018/0229270 A1
(43) Pub. Date: Aug. 16, 2018

(54) LINEAR VIBRATION MOTOR

(71) Applicant: Nidec Copal Corporation, Tokyo (JP)

(72) Inventors: Risa NAKAZATO, Tokyo (JP); Masaya ENDO, Tokyo (JP); Kazuya MOCHIDA, Tokyo (JP)

(73) Assignee: Nidec Copal Corporation, Tokyo (JP)

(21) Appl. No.: 15/577,159

(22) PCT Filed: May 26, 2016
(86) PCT No.: PCT/JP2016/065562

§ 371 Date: Apr. 18, 2018

(30) Foreign Application Priority Data
May 29, 2015 (JP) 2015-109787

(51) Int. Cl. B06B 1/04; H02K 33/16; H02K 33/06

(52) U.S. Cl. CPC B06B 1/045; F16F 1/027; H02K 33/06; H02K 33/16

(57) ABSTRACT

A linear vibration motor is provided with a frame, a weight, and a plate spring 4, and is also provided with weight side drive members disposed within a through hole in the weight and attached with the through hole space along the direction of vibration therebetween, and a frame side drive member supported by the frame and disposed so as to pass through the through hole space. The plate spring 4 has a frame side seating part 4A attached to the frame, a weight side seating part attached to an end surface of the weight, and an elastic deformation part that elastically deforms between the frame side seating part and the weight side seating part. The weight side drive members are disposed so as to protrude from the end surface of the weight in the range of the thickness of the plate spring 4.

### CROSS-REFERENCE TO RELATED APPLICATIONS

This is a U.S. national phase application under 35 U.S.C. § 371 of International Patent Application No. PCT/JP2016/065562, filed May 26, 2016, and claims benefit of priority to Japanese Patent Application No. 2015-109787, filed May 29, 2015. The entire contents of these applications are hereby incorporated by reference.

### FIELD OF TECHNOLOGY

The present invention relates to a linear vibration motor.

### BACKGROUND

Vibration motors (or “vibration actuators”) are often built into mobile electronic devices as devices for communicating to the users, through vibration, that there has been a signal, such as an incoming call or an alarm. Moreover, vibration motors have been of interest in recent years as devices for achieving haptics (feedback through the sense of touch) in human interfaces such as touch panels, and the like.

Among the various forms of vibration motors that are under development, linear vibration motors are able to generate relatively large vibrations through linear reciprocating vibrations of a movable element. In conventional linear vibration motors, a weight, as a movable element, is supported on a frame, which serves as a stator, through a spring, with a coil installed on either the frame or weight side, and a magnet is installed on the other side, where the direction of the electromagnetic driving force that acts between the coil and the magnet is matched to the direction of elasticity of the spring, and an AC signal of the resonant frequency that is determined by the mass of the weight and by the modulus of elasticity of the spring is applied to the coil to cause the movable element to undergo linearly reciprocating vibration.

Such a linear vibration motor must be thin in even the direction of vibration, while securing an adequate vibration stroke, where the thickness of the spring, which is disposed outside of the vibration stroke, needs to be extremely thin when the spring is compressed. In response to this need, linear vibration motors that use leaf springs have been developed, as disclosed in Japanese Unexamined Patent Application Publication 2014-176841. So that the thickness of the leaf spring when compressed will be equal to the plate thickness, the leaf spring is formed by cutting out a seat part and an elastically deformable part from a single flat plate.

In this prior art, a hole is formed along the direction of vibration in the center portion of the weight, a magnet is installed within the hole, and the leaf spring is disposed between an end face, of the weight, that is perpendicular to the direction of vibration and a frame (case) that supports the weight. The leaf spring is made from a weight-side seat part and a case-side seat part, and an elastically deformable part that connects therebetween, are cut out from a single plate, where the weight-side seat part is attached to the end face of the weight.

### SUMMARY

In the prior art described above, a magnet is installed in a hole that extends in the direction of vibration within the weight, and the weight-side seat part of the leaf spring is attached to the magnet, and thus even when attempts are made to increase the driving force by increasing the separation of the north and south poles of the magnet along the direction of vibration, the width of that separation is limited to the thickness of the weight in the direction of vibration. On the other hand, when the thickness of the weight is increased in order to increase the distance of separation between the north and south poles of the magnet along the direction of vibration, the proportion occupied by the thickness of the weight, of the limited space over which vibration is possible in the direction of vibration, is increased, and thus there is a problem in that this reduces the effective vibration stroke. Moreover, when the north and south ends of the magnet are caused to protrude from the thickness of the weight along the direction of vibration, the vibration stroke is limited by the end faces, of the magnet, along the direction of vibration, producing the same problem as when the thickness of the weight is increased, in that the effective vibration stroke is reduced.

In the present invention, the handling of such problems is an example of the problem to be solved. That is, the object of the present invention is to increase the driving force without having an effect on the vibration stroke in a linear vibration motor wherein a leaf spring is disposed between a weight and a frame.

In order to achieve such an object, the linear vibration motor of the present invention is equipped with the following structures:

A linear vibration motor comprising: a frame; a weight that has an end face that is perpendicular to a direction of linear vibration and that also has a through hole, in the center portion thereof, along the direction of vibration; a leaf spring that is attached between the frame and the end face of the weight; a weight-side driving member, provided within the through hole, having, therein, a through space along the direction of vibration; and a frame-side driving member, supported on the frame, and provided passing through the through space, wherein: the weight-side driving member is provided protruding from the end face of the weight in the range of a plate thickness of the leaf spring; and the weight is caused to vibrate, along the direction of vibration, by a driving force generated between the weight-side driving member and the frame-side driving member.

In the linear vibration motor according to the present invention, having the distinctive features described above, the weight-side driving member is disposed protruding from the end face of the weight in the range of the plate thickness of the leaf spring, enabling an increase in the driving force, without having an effect on the vibration stroke, in a linear vibration motor wherein a leaf spring is disposed between an end face of a weight and a frame.

### BRIEF DESCRIPTIONS OF THE DRAWINGS

FIG. 1 is an explanatory diagram (a cross-sectional view) illustrating an overall structure of a linear vibration motor according to an embodiment according to the present invention.

FIG. 2 is an explanatory diagram (an assembly perspective diagram) illustrating the overall structure of a linear vibration motor according to an embodiment according to the present invention.

FIG. 3 is an explanatory diagram (a plan view with the case removed) illustrating the overall structure of a linear vibration motor according to an embodiment according to the present invention.

FIG. 4 is a cross-sectional view along the section X-X in FIG. 3.

FIG. 5 is an explanatory diagram (a cross-sectional view) illustrating a modified example of a linear vibration motor according to an embodiment according to the present invention.

FIG. 6 is an explanatory diagram (a cross-sectional view) illustrating an overall structure of a linear vibration motor according to another embodiment according to the present invention.

FIG. 7 is an explanatory diagram (an assembly perspective diagram) illustrating the overall structure of a linear vibration motor according to another embodiment according to the present invention.

FIG. 8 is an explanatory diagram illustrating an electronic device (a mobile information terminal) in which is provided a linear vibration motor according to an embodiment according to the present invention.

### DETAILED DESCRIPTION

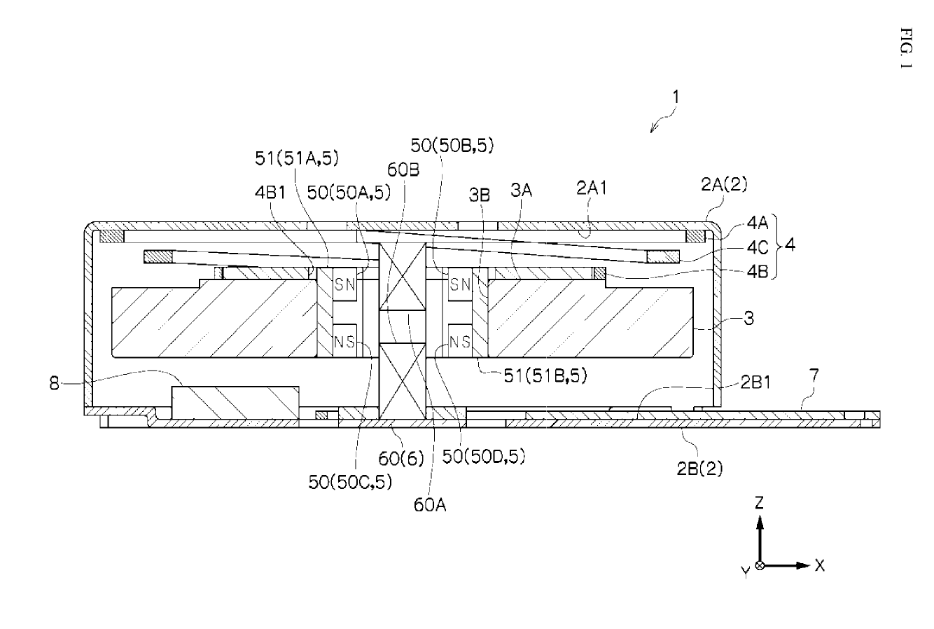

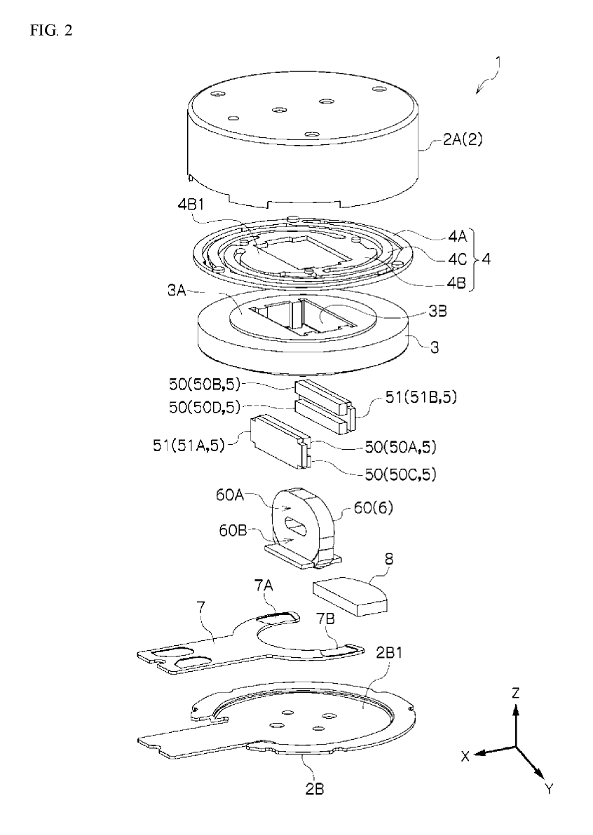

Examples according to the present invention will be explained below in reference to the drawings. FIG. 1 and FIG. 2 illustrate the overall structure of a linear vibration motor according to an embodiment according to the present invention. A linear vibration motor 1 comprises a frame 2, a weight 3, a leaf spring 4, a weight-side driving member 5, and a frame-side driving member 6. In this linear vibration motor 1, the frame 2 and the frame-side driving member 6 serve as a stator, and the weight 3 and the weight-side driving member 5 serve as an oscillator (a movable element), where the oscillator undergoes reciprocating vibration linearly along the Z direction in the figures. In the figures below, the Z direction is defined as the direction of vibration, where two axial directions that are mutually perpendicular and perpendicular to the direction of vibration are defined as the X and Y directions.

The frame 2 is a member for supporting, through the leaf spring 4, the weight 3, so as to enable vibration thereof, and in the example illustrated in FIG. 1 and FIG. 2, a bottom plate 2B and a case 2A are provided surrounding the periphery of the weight 3 and the leaf spring 4. In FIG. 1 and FIG. 2, a vibration space for the weight 3 is formed within the cylindrical case 2A, where the weight 3 is supported, through the leaf spring 4, on the inner surface 2A1 of the case 2A, which is perpendicular to the direction of vibration, and the frame-side driving member 6 is supported on the bottom face 2B1 of the bottom plate 2B, which is perpendicular to the direction of vibration. Moreover, a cushion member 8 (of rubber, or the like) is attached to the bottom face 2B1 in order to prevent the production of noise through the weight 3 striking the bottom face 2B1 during vibration.

The weight 3 has an end face 3A that is perpendicular to the direction of vibration, and also has a through hole 3B, in the center thereof, that extends along the direction of vibration. The end face 3A serves as the attaching portion to which a portion of the leaf spring 4 (the weight-side seat part 4B) is attached. The interior of the through hole 3B serves as the attaching portion to which the weight-side driving member 5 is attached. In the example depicted in FIG. 1 and FIG. 2, the weight 3 is provided in a circular column shape that has a prescribed thickness extending in the direction of vibration, but there is no particular limitation on this shape.

The leaf spring 4 is attached between the frame 2 and an end face 3A of the weight 3, and has a frame-side seat part 4A that is attached to the frame 2 (the inner surface 2A1 of the case 2A), a weight-side seat part 4B that is attached to the end face 3A of the weight 3, and an elastically deformable part 4C that undergoes elastic deformation, between the frame-side seat part 4A and the weight-side seat part 4B. The leaf spring 4 is formed from a single plate, where each of the parts, that is, the frame-side seat part 4A, the weight-side seat part 4B, and the elastically deformable part 4C, is formed through cutting out from a single flat plate, so that the leaf spring 4, when in the most compressed state, forms a single flat plate.

The weight-side driving member 5 is disposed within the through hole 3B of the weight 3, and is attached with the through space that extends in the direction of vibration enclosed therein. The frame-side driving member 6 is supported on the frame 2, and is provided in a state that passes through the through space in the through hole 3B of the weight 3. The weight-side driving member 5 and the frame-side driving member 6 are members that cause the weight 3 to vibrate, along the direction of vibration, by the driving force that is generated therebetween, where, for example, of the weight-side driving member 5 and the frame-side driving member 6, one is a coil and the other is a magnetic pole member that is equipped with a magnet 50.

In the example that is depicted in FIG. 1 and FIG. 2, the weight-side driving member 5 is a magnetic pole member that is provided with a magnet 50 and a yoke 51, where the frame-side driving member 6 is a coil 60, but, conversely, the weight-side driving member 5 may be a coil instead, and the frame-side driving member 6 may be a magnetic pole member made from a magnet and a yoke. At this time, the layout relationship of the coil and the magnetic pole member that is provided with a magnet is such that the direction of the electric current that flows in the coil and the direction of the magnetic flux of the magnetic pole member, which is perpendicular thereto, are both perpendicular to the direction of vibration, so as to produce a driving force along the direction of vibration (the Z direction in the figure).

In the example depicted in FIG. 1 and FIG. 2, the coil 60 is provided with a pair of linear parts 60A and 60B that are perpendicular to the direction of vibration, where the linear part 60A is supported on the bottom face 2B1 so that the linear parts 60A and 60B are parallel, spaced out along the direction of vibration. That is, in the coil 60, a wire is wrapped within a plane that extends along the direction of vibration. A flexible circuit board 7 is supported on the bottom face 2B1, and the ends of the wire of the coil 60 are connected to terminals 7A and 7B of the flexible circuit board 7.

The magnet 50 in the weight-side driving member 5 is disposed with the linear part 60A of the coil 60 held therein, and has a pair of magnets 50A and 50B that produce magnetic flux that is perpendicular to the direction of vibration, and a pair of magnets 50C and 50D that produce magnetic flux that is perpendicular to the direction of vibration, disposed with the linear part 60B of the coil 60 therebetween. Moreover, the yoke 51 of the weight-side driving member 5 comprises a yoke 51A that connects to magnets 50A and 50C that are disposed for each of the pair of linear parts 60A and 60B, and a yoke 51B that connects to magnets 50B and 50D that are disposed for each of the pair of linear parts 60A and 60B.

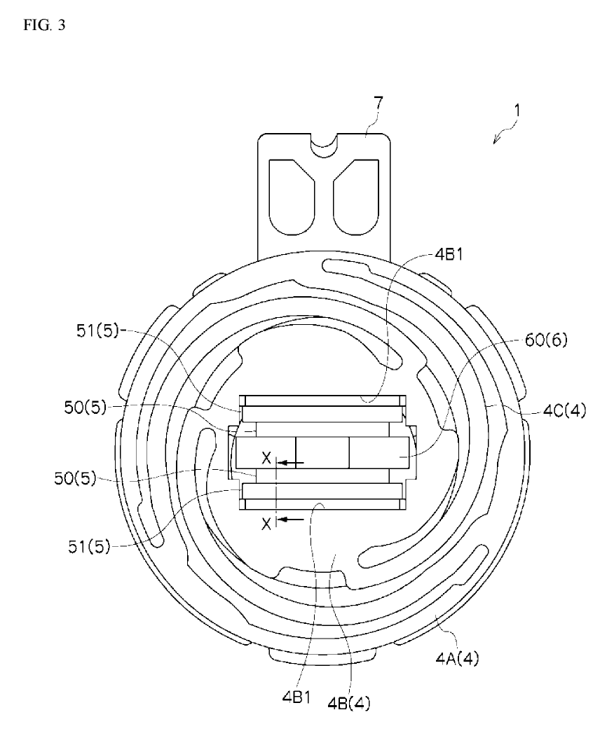

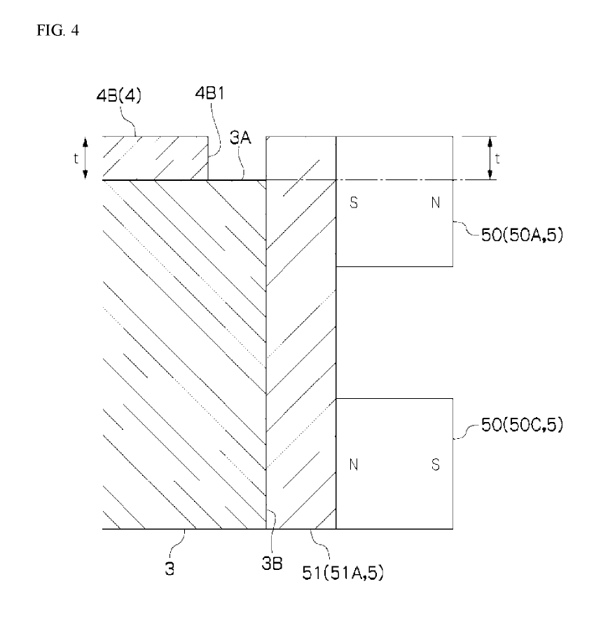

FIG. 3 is a plan view of the linear vibration motor 1 with the case 2A removed, and FIG. 4 is a cross-sectional view along the section X-X thereof. In the linear vibration motor 1, the weight-side driving member 5 that is disposed within the through hole 3B of the weight 3 is disposed protruding from the end face 3A of the weight 3 by an amount equal to the plate thickness t of the leaf spring 4. In FIG. 4, the weight-side driving member 5 is a magnetic pole member that is equipped with a magnet 50 and a yoke 51, where the upper portion of the magnet 50 (50A) and yoke 51 protrude higher than the end face 3A of the weight 3 in a range that is the plate thickness t of the leaf spring 4. In the example in the figure, the top end face of the weight-side driving member 5 is coplanar with the top face of the weight-side seat part 4B of the leaf spring 4, but there is no limitation thereto, but rather, instead, the top end face of the weight-side driving member 5 may be at or below the top face of the weight-side seat part 4B of the leaf spring 4. Here a hole portion 4B1, for accommodating the protruding portion of the weight-side driving member 5, is provided in the weight-side seat part 4B.

Such a linear vibration motor 1 makes it possible to cause the weight 3 to undergo reciprocating vibration along a linear direction of vibration, through the driving force produced between the weight-side driving member 5 and the frame-side driving member 6. In the example illustrated in FIG. 1 through FIG. 4 an oscillating current (and AC current of a resonant frequency that is determined by the mass of the weight 3 and the modulus of elasticity of the leaf spring 4) is applied to the frame-side driving member 6, which is a coil 60, to cause the weight 3, which is attached to the weight-side driving member 5, to undergo reciprocating vibration in the direction of vibration.

In addition, when compared to the prior art, wherein the end face 3A of the weight 3 and the top end face of the weight-side driving member are coplanar, in this linear vibration motor 1 the height of the weight-side driving member 5 in the direction of vibration is higher by an amount commensurate with the plate thickness t of the leaf spring, making it possible to increase the spacing between the magnets 50A and 50C (50B and 50D), increasing the magnetic flux that traverses the linear parts 60A and 60B of the coil 60 when the weight 3 is vibrating, enabling an increase in the driving force. At this time, the amount of increase of the height of the weight-side driving member 5 in the direction of vibration is stopped at an amount commensurate with the plate thickness t of the leaf spring, thus enabling an increase in the driving force without any effect whatsoever on the effective vibration stroke of the weight 3.

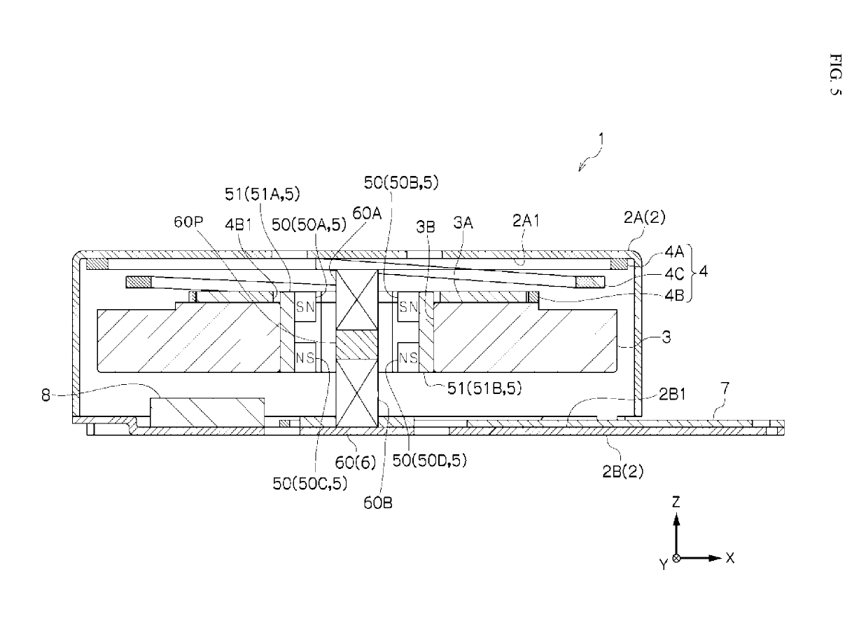

FIG. 5 depicts a modified example of the linear vibration motor 1 that is described above. Identical reference symbols are assigned to parts that are identical to the explanation set forth above, and redundant explanations are omitted. In this example, the coil 60, which is the frame-side driving member 6, comprises a core material 60P that is a magnetic material, where a lead wire is wound around the core material 60P.

In this way, the hollow core of the coil 60 is filled with a core material 60P of a magnetic material, and thus the magnetic circuit comprising the magnets 50A through 50D can increase the magnetic flux that traverses the linear parts 60A and 60B of the coil 60 by reducing the magnetic flux that connects between the magnet 50A and the magnet 50C, or the magnet 50B and the magnet 50D, that are disposed on one-side of the coil 60. Through this, the driving force that acts on the weight-side driving member 5 can be increased through this as well, enabling a shortening of the time required to ramp up to a full vibration of the weight 3.

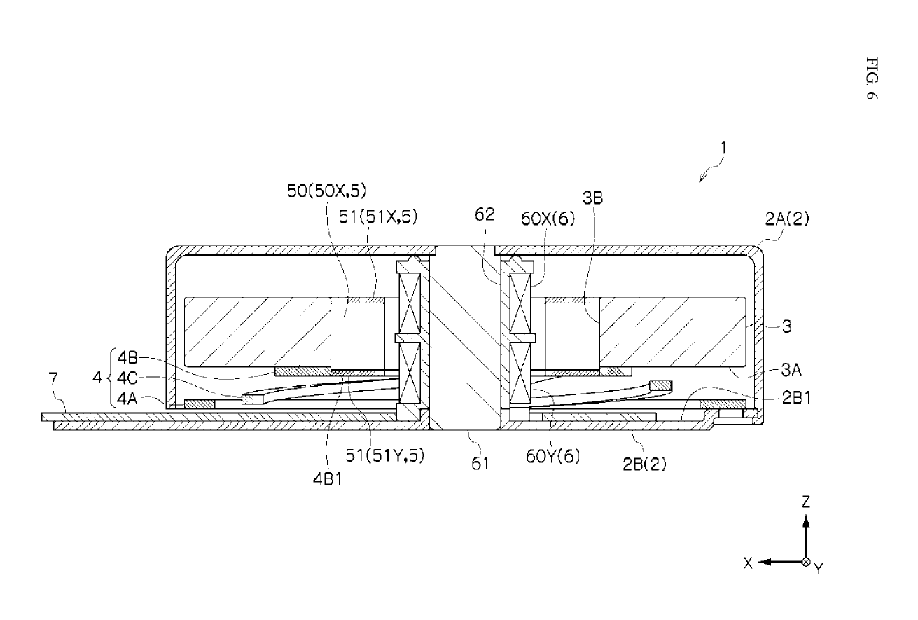

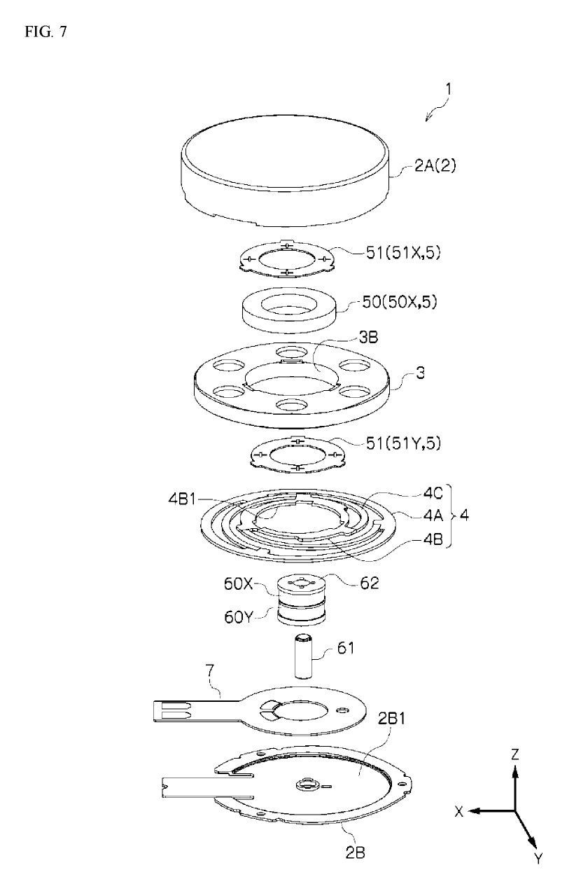

FIG. 6 and FIG. 7 illustrate another embodiment of a linear vibration motor 1. Identical reference symbols are assigned to parts that are identical to the explanation set forth above, and redundant explanations are omitted. In this example, the weight-side driving member 5 comprises an annular magnet 50 (50X) and yokes 51 (51X and 51Y) that are connected to the top face and bottom face thereof. Here the magnet 50 (50X) is magnetized in the direction of vibration (the Z direction in the figure). Moreover, the frame-side driving member 6 comprises a pair of coils 60X and 60Y that are wound onto a bobbin 62 on a pole 61 that is supported on the bottom plate 2B and that stands extending along the direction of vibration. The coil 60X and the coil 60Y are wound in mutually opposing directions. Note that while an example wherein yokes 51 (51X and 51Y) are provided is illustrated in the example in the figure, the yokes 51 (51X and 51Y) may be omitted instead.

In the weight 3, an end face 3A faces the bottom plate 2B, with a leaf spring 4 disposed between the end face 3A and the bottom face 2B1, where the frame-side seat part 4A of the leaf spring 4 is attached to the bottom face 2B1, and the weight-side seat part 4B of the leaf spring 4 is attached to the end face 3A.

Additionally, the yoke 51 (51Y) of the weight-side driving member 5 that is attached in the through hole 3B of the weight 3 protrudes, from the end face 3A of the weight 3 in the range of the plate thickness of the leaf spring 4. While, in the example in the figure, the yoke 51 (51Y) protrudes so that the bottom face of the yoke 51 (51Y) is coplanar with the bottom face of the weight-side seat part 4B of the leaf spring 4, there is no limitation thereto, but may instead be in the range of the plate thickness of the leaf spring 4. Note that if the yokes 51 (51X and 51Y) are omitted, the bottom face of the magnet 50 (50X) and the bottom face of the weight-side seat part 4B of the leaf spring 4 may be coplanar, the bottom face of the magnet 50 (50X) may instead protrude from the end face 3A of the weight 3 so as to be therebelow.

In the example depicted in FIG. 6 and FIG. 7 as well, the spacing between the magnetic poles of the weight-side driving member 5, in the direction of vibration, can be increased, enabling an increase in the magnetic flux that traverses the coils 60X and 60Y, thus enabling an increase in the driving force for vibrating the weight 3 along the direction of vibration. At this time, the protrusion of the weight-side driving member 5 from the end face 3A is stopped within the plate thickness of the leaf spring 4, enabling an increase in the driving force without having an effect on the vibration stroke of the weight 3.

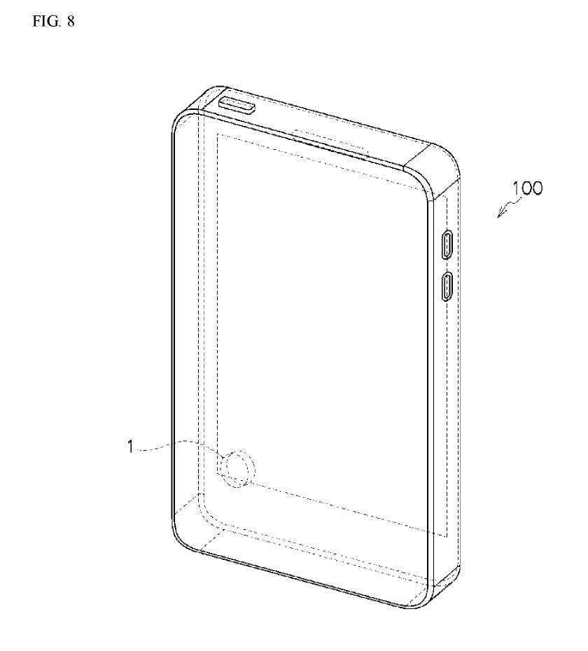

FIG. 8 illustrates a mobile information terminal 100 as one example of a mobile electronic device equipped with a linear vibration motor 1 according to an embodiment according to the present invention. The mobile information terminal 100 that is equipped with the compact linear vibration motor 1 that is thin, enabling a reduction in thickness, and that vibrates effectively along the direction of thickness, to communicate to users, through effective vibrations through an adequate driving force, incoming calls in a communication function, or the beginning or end of an operation, such as an alarm function. Moreover, in the mobile information terminal 100, the reduced thickness of the linear vibration motor 1 enables superior portability and superior design. The linear vibration motor 1 is able to transmit information through applying a vibration effectively to, for example, the finger of the user when using a touch panel, through the ability to apply an effective vibration along the direction of thickness of a mobile information terminal 100 that itself is of reduced thickness.

While embodiments according to the present invention were described in detail above, referencing the drawings, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A linear vibration motor comprising:
a frame;
a weight that has an end face that is perpendicular to a direction of linear vibration and that also has a through hole, in the center portion thereof, along the direction of vibration;
a leaf spring that is attached between the frame and the end face of the weight;
a weight-side driving member, provided within the through hole, having, therein, a through space along the direction of vibration; and
a frame-side driving member, supported on the frame, and provided passing through the through space, wherein:
the weight-side driving member is provided protruding from the end face of the weight in the range of a plate thickness of the leaf spring; and
the weight is caused to vibrate, along the direction of vibration, by a driving force generated between the weight-side driving member and the frame-side driving member.

2. THE linear vibration motor as set forth in claim 1, wherein:
the leaf spring has a frame-side seat part that is attached to the frame, a weight-side seat part that is attached to the end face of the weight, and an elastically deformable part that undergoes elastic deformation, between the frame-side seat part and the weight-side seat part.

3. THE linear vibration motor as set forth in claim 1, wherein:
either the weight-side driving member or the frame-side driving member is a coil; and
the other is a magnetic pole member equipped with a magnet.

4. THE linear vibration motor as set forth in claim 1, wherein:
the weight-side seat part of the leaf spring comprises a hole portion for containing a protruding portion of the weight-side driving member.

5. THE linear vibration motor as set forth in claim 1, wherein:
the frame-side driving member is a coil comprising a pair of linear parts that are perpendicular to the direction of vibration, the pair of linear parts are laid out, in parallel, along the direction of vibration;
the weight-side driving member is disposed on either side of a linear part of the coil and comprises:
a pair of magnets forming a magnetic flux perpendicular to the direction of vibration is provided for each of the pair of linear parts, and
a yoke connecting the magnets provided for each of the pair of linear parts.

6. THE linear vibration motor as set forth in claim 3, wherein:
in the coil, the lead wire is wound around a core material of a magnetic material.

7. THE mobile electronic device comprising a linear vibration motor as set forth in claim 1.
